(19) United States
(12) Patent Application Publication
(10) Pub. No.: US 2026/0295428 A1
(43) Pub. Date: Oct. 1, 2026

(54) AI-DRIVEN NARRATIVE DECISION-MAKING ENGINE IN A GAME DEVELOPMENT SYSTEM

(71) Applicant: Microsoft Technology Licensing, LLC, Redmond, WA (US)

(72) Inventors: Lucas Fernán SALVADOR, Bellevue, WA (US); Kailin ZHENG, Seattle, WA (US); Kevin Jusef BASTIAN, Puebla (MX); Peter BODIK, Kirkland, WA (US); Francisco Jose BOLAÑOS MONTES DE OCA, New York, NY (US); Miles Daniel FERTEL, Seattle, WA (US); Kristine Kimiko Ishii GOLUS, Kirkland, WA (US); Abdelrahman Khaled Abdo MOHAMED, Seattle, WA (US); Dylan OCHOA, Seattle, WA (US)

(21) Appl. No.: 19/092,867

(22) Filed: Mar. 27, 2025

(51) Int. Cl. A63F 13/67; A63F 13/58

(52) U.S. Cl. CPC A63F 13/67; A63F 13/58

(57) ABSTRACT

Methods, systems, and computer storage media for providing AI-driven narrative decision-making management using an AI-driven narrative decision-making engine in an artificial intelligence (AI) system are described. The AI-driven narrative decision-making engine is designed to facilitate dynamic, context-aware decision-making in game environments. In operation, the AI-driven narrative decision-making engine functions as controlled decision engine, integrating with game development frameworks to enhance character interactions (e.g., non-playable characters—NPCs) by selecting from predefined developer-curated actions. Rather than generating open-ended responses, the AI-driven narrative decision-making engine processes structured text inputs, evaluates game state variables, and determines the most appropriate action based on past interactions, character memory, and game world context. The AI-driven narrative decision-making engine relies on a structured input-output architecture where developers provide narrative descriptions of NPCs, environmental conditions, and possible predefined developer-curated actions in structured natural language. AI-driven narrative decision-making engine processes this data using a constrained selection model, ensuring NPC decisions align with constraints while maintaining narrative coherence.

### BACKGROUND

Game developers rely on game development platforms to create, refine, and enhance interactive experiences, including narrative-driven gameplay, dynamic NPC (Non-Player Character) behaviors, and immersive world-building. Game development platforms provide a suite of tools that allow developers to define game logic, character interactions, and environmental responses through scripting languages, decision trees, and predefined assets. Traditional game development heavily relies on manual scripting, requiring developers to explicitly define NPC behaviors, dialogue trees, and event triggers using complex logic systems and rule-based decision-making. For example, in traditional systems, a developer might manually script every possible NPC reaction to a player's actions using Excel spreadsheets or custom dialogue editors, requiring careful planning and iteration to ensure a coherent player experience. This process can be labor-intensive and time-consuming, often resulting in rigid, repetitive interactions that limit the flexibility of NPC responses. Additionally, the complexity of manually defining game-wide behavioral logic makes it difficult to scale interactions across large, open-world games.

### SUMMARY

Various aspects of the technology described herein are generally directed to systems, methods, and computer storage media for, among other things, providing AI-driven narrative decision-making management using an AI-driven narrative decision-making engine in a game development system. AI-driven narrative decision-making management refers to the structured process of curating and controlling AI-assisted decision-making within a game environment. AI-driven narrative decision-making management ensures that AI-driven character actions and responses remain narratively coherent, contextually appropriate, and developer-controlled while dynamically adapting to in-game events and player interactions.

The AI-driven narrative decision-making engine is designed to facilitate dynamic, context-aware decision-making in game environments. The AI-driven narrative decision-making engine functions as a controlled decision engine, integrating with game development frameworks to enhance character interactions (e.g., non-playable characters-NPCs) by selecting from predefined developer-curated actions. Rather than generating open-ended responses, the AI-driven narrative decision-making engine processes structured text inputs, evaluates game state variables, and determines the most appropriate action based on past interactions, character memory, and game world context.

The AI-driven narrative decision-making engine relies on a structured input-output architecture where developers provide narrative descriptions of NPCs, environmental conditions, and possible actions. AI-driven narrative decision-making engine processes this data using a constrained selection model, ensuring NPC decisions align with predefined constraints while maintaining narrative coherence. By tracking world state and NPC-specific memory, the AI-driven narrative decision-making engine enables emergent storytelling where characters evolve over time in response to player actions.

Designed for scalability, the AI-driven narrative decision-making engine operates within a structured framework that exponentially increases interaction complexity without requiring exhaustive manual scripting. The AI-driven narrative decision-making engine can be integrated as a plug-and-play Software Development Kit (SDK), such that it connects with game engines to trigger animations, dialogues, or environmental changes based on AI-selected outcomes. By maintaining developer oversight over all possible outputs, the AI-driven narrative decision-making engine ensures consistency, safety, and high-quality in-game decision-making.

In operation, character data associated with a character of a game is accessed. A character profile is generated for the character, where the character profile is associated with AI-driven decision-making for the character in the game. A determination is made that a decision point that is associated with the game has been reached. Based on the determination that the character has reached the decision point; a prompt is generated for an AI-driven decision-making model using the character profile. Using the AI-driven decision-making model, an output associated with a predefined action of the character is generated. A game sequence associated with the predefined action is executed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A-1C are AI-driven decision-making schematics associated with an AI-driven decision-making workflow of an AI-driven narrative decision-making engine, in accordance with aspects of the technology described herein;

FIG. 2A is a block diagram of an exemplary AI system including an AI-driven narrative decision-making engine, in accordance with aspects of the technology described herein;

FIG. 2B is a flow diagram associated with an exemplary AI system including an AI-driven narrative decision-making engine, in accordance with aspects of the technology described herein;

FIG. 3 provides a first exemplary method of providing AI-driven narrative decision-making management using an AI-driven narrative decision-making engine, in accordance with aspects of the technology described herein;

FIG. 4 provides a second exemplary method of providing AI-driven narrative decision-making management using an AI-driven narrative decision-making engine, in accordance with aspects of the technology described herein;

FIG. 5 provides a third exemplary method of providing AI-driven narrative decision-making management using an AI-driven narrative decision-making engine, in accordance with aspects of the technology described herein;

FIG. 6 provides a block diagram of an exemplary computing system suitable for use in implementing aspects of the technology described herein;

FIG. 7 provides a block diagram of an exemplary distributed computing environment suitable for use in implementing aspects of the technology described herein; and

FIG. 8 provides a block diagram of an exemplary computing environment suitable for use in implementing aspects of the technology described herein.

### DETAILED DESCRIPTION

### Overview

Modern game development platforms provide computing environments for designing, scripting, and executing interactive experiences. These platforms integrate multiple subsystems, including physics engines, rendering pipelines, animation frameworks, AI behavior models, and scripting languages, to create dynamic game worlds. Developers utilize state machines, event-driven scripting, and decision trees to define character interactions, environmental responses, and quest progressions.

Non-playable character (NPC) behaviors are typically managed through finite state machines (FSMs) or behavior trees, which dictate a set of predetermined responses based on predefined conditions. These structures require explicit rule definition, where developers manually script transitions between states and define how characters react to external stimuli. Dialogue systems operate similarly, relying on branching dialogue trees or predefined text sequences to simulate player interactions. NPCs may be assigned variables to track reputation, hostility, or affinity, but these must be explicitly programmed, limiting adaptability across varied scenarios.

For large-scale game environments, developers leverage database-driven narrative systems, where player choices and world events are recorded as structured data points. These data sets influence quest progressions and world states, but dynamic response generation remains dependent on manually scripted logic. Game engines may provide toolkits for managing world states, object hierarchies, and AI behavior modules, yet NPC decision-making remains a labor-intensive process, requiring direct developer intervention to ensure consistency and narrative coherence.

Conventionally, game platforms are not configured with a comprehensive computing logic and infrastructure to effectively provide controlled AI-assisted decision-making within a game environment. Traditional game development relies heavily on manual scripting to define NPC behaviors, dialogues, and game event responses. Developers use large spreadsheets, dialogue editors, and rule-based systems such as if-then logic trees to account for every possible interaction, requiring extensive planning and iteration. As game worlds expand, this approach becomes increasingly time-consuming, difficult to scale, and prone to inconsistencies. NPCs often exhibit rigid, repetitive behaviors, breaking immersion when they fail to respond naturally to dynamic gameplay.

To address these limitations, some developers have experimented with LLMs to generate real-time NPC dialogue and actions. However, LLMs lack an inherent understanding of game constraints, often hallucinating responses that contradict established game mechanics or lore. Without proper safeguards, AI-generated content can introduce unpredictable, inappropriate, or nonsensical outputs, making it unreliable for maintaining narrative coherence and player experience.

By way of example, in a traditional RPG, a developer scripts an NPC blacksmith to respond to player interactions. Using a rule-based system, the developer manually defines responses based on if-then logic:

If the player greets the blacksmith politely, he offers a discount.
If the player insults him, he refuses service.
If the player has previously saved the town, he provides a free repair.

To implement this, the developer creates a dialogue tree, maps all possible interactions, and updates NPC variables manually based on player choices. As the game world expands, new interactions require rewriting old conditions, increasing development complexity.

If the developer tries to introduce an LLM-generated dialogue system to make interactions feel more organic, the AI might hallucinate and generate responses that contradict the game's logic. For instance, the blacksmith might offer an unearned reward, acknowledge events that never happened, or even forget past interactions. This unpredictability makes AI-generated responses risky, while manual scripting remains too rigid and time-consuming. As a result, NPCs in large-scale games often feel static and repetitive, unable to respond dynamically to evolving player choices without significant developer intervention. As such, a more comprehensive AI system—with an alternative basis for performing AI-driven narrative decision-making management—can improve computing operations and interfaces for artificial intelligence systems.

### Description of Technical Solution

At a high level, the AI-driven narrative decision-making engine operates as a structured selection system that enables dynamic, context-aware behavior in characters (e.g., non-playable characters (NPCs)) by leveraging large language models (LLMs) in a controlled and predictable manner. Rather than allowing the LLM to generate open-ended or arbitrary content, the AI-driven narrative decision-making engine is designed to operate within a constrained framework defined entirely by the developer. Developers provide the AI-driven narrative decision-making engine with rich narrative descriptions of the game world, including character backstories, environmental conditions, and recent events. These descriptions are written in natural language and are used to build a rolling context that reflects the current state of the game world and the internal memory of each NPC.

At specific decision points, the developer also provides a curated list of possible actions or responses in natural language. The LLM receives the current context and the list of predefined actions and selects the most narratively coherent action based on the information available. In one embodiment, the output of the LLM is not a freeform generation but an index referencing one of the provided predefined actions, ensuring the decision remains safe, appropriate, and consistent with the game's rules and narrative logic. The LLM selects an action by returning an index from predefined options, along with a narrative-grounded output—such as dialogue or reasoning—ensuring emotionally consistent, developer-approved behavior within the game's storyline. This architecture eliminates the possibility of hallucinated outputs by removing generative freedom and instead employing the LLM as a context-sensitive classifier.

Each NPC maintains its own evolving state, built from prior events and character-specific context, which informs future decisions. The world state and character memory are managed as structured text descriptions that are updated continuously as new actions are taken. These descriptions feed into the LLM alongside the developer-defined choices, enabling decisions that feel individualized and reactive without requiring hand-authored branching logic or behavior trees. Because the inputs and outputs remain in natural language, writers and designers can craft personalities and narrative arcs without deep technical knowledge.

The AI-driven narrative decision-making engine integrates with a game's runtime by exposing an interface that allows developers to send context, receive decision indexes, and execute the associated in-game animations, dialogue, or logic flows already programmed to handle those outcomes. Developers can manually inspect the LLM's choice and its reasoning—generated as a narrative justification—enabling transparent debugging and refinement. This justification can be stored for logs or used to diagnose behavior during testing.

It is contemplated that the AI-driven narrative decision-making engine can support two distinct types of justifications: prompt narrative justification and result narrative justification. Prompt narrative justification is embedded in the structured input sent to the LLM and is essential for grounding the model's reasoning in the game's narrative logic. This justification is not simply metadata—it informs the model how to frame its decision within the character's personality, past actions, and current situation. For example, the prompt may include lines like, “Rebecca is brave and protective, especially when her family is threatened.” This guidance helps the LLM choose a response that aligns with the character's emotional and narrative arc. It shapes the model's internal reasoning and narrows the interpretive context to prioritize story consistency.

In contrast, result narrative justification is part of the output returned by the LLM. It can take the form of a dialogue line or a short explanation, offering insight into why the NPC took a specific action. While the game designer could choose to show the narrative justification in-game (e.g., through NPC dialogue), even when hidden it also serves an important development function: enabling developers to trace decisions, verify logic, and debug inconsistencies. It provides transparency into the AI's choice-making process without compromising control or safety. The architecture supports scalability, as each additional character or action simply extends the narrative richness of the world without requiring proportional increases in scripting effort.

Overall, the AI-driven narrative decision-making engine transforms the LLM into a deterministic, explainable decision module embedded within the game loop. By forcing both the inputs and outputs to remain within developer-defined narrative bounds, it balances the expressive power of AI with the predictability, polish, and control required for safe and high-quality game development.

Operationally, the AI-driven narrative decision-making engine provides a structured, narrative-centric approach to dynamically controlling NPC behavior in open-world game environments. Instead of relying on traditional systems that require developers to manually script every possible interaction using decision trees or complex rule sets, the AI-driven narrative decision-making engine allows developers to define NPC personalities, backstories, relevant world events, and contextually appropriate actions in plain English. At runtime, the AI-driven narrative decision-making engine uses this curated information to select the most fitting action from a predefined list, guided by character-specific histories and world state. This ensures that NPC responses remain coherent and consistent with both their established traits and the evolving narrative, without introducing the unpredictability associated with open-ended generative AI.

Each decision is based on a rolling context composed of developer-authored text describing the NPC's experiences, motivations, and past interactions. For example, a single NPC might regard the player differently based on whether they were helped or mocked in a previous quest, and the AI will draw from these contextual details to determine the appropriate response—such as whether to join the player in battle, refuse aid, or reward them after a mission. All potential actions are filtered and validated by the developer during design, eliminating risks of inappropriate or unexpected output. By limiting the LLM to a selection task rather than a generative one, the AI-driven narrative decision-making engine maximizes narrative richness while maintaining safety and fidelity to the game's logic.

As more NPCs and interactions are layered into the AI-driven narrative decision-making engine, the range of emergent behaviors grows exponentially without requiring proportional scripting effort. In complex scenarios like a murder mystery, for instance, each NPC can respond differently based on their role and memory—one might rush to alert authorities, another might investigate the scene, while a third begins hurling accusations—all selected from pre-approved behaviors. This coordination results in lifelike, unscripted-feeling gameplay that is nonetheless completely within the control of the developer.

Technically, the AI-driven narrative decision-making engine operates through a combination of structured narrative inputs, context-aware memory tracking, and constrained LLM inference. Developers feed in character context, world events, and an array of candidate actions. The AI-driven narrative decision-making engine packages this into a structured prompt, and the LLM selects the action best aligned with the scenario. The chosen action is then passed back to the game engine as an index tied to pre-programmed responses such as animations, dialogue, or environmental changes. This architecture avoids real-time content generation and ensures every outcome has been tested, reviewed, and polished beforehand.

Unlike reinforcement learning models or traditional AI behavior systems, this engine does not “learn” from gameplay or dynamically alter its internal weights. Instead, it acts as a deterministic selector operating within tightly scoped constraints, making it transparent, testable, and controllable. Each NPC operates with a unique decision history, enabling them to evolve over time and maintain persistent relationships with the player and the world around them. This makes their behavior feel both emotionally authentic and grounded in the game's logic.

Key benefits of the AI-driven narrative decision-making engine include increased safety (as generative outputs are used internally to guide predefined actions and optionally no real-time generative content directly reaches the player), improved scalability (each added action increases combinatorial interaction potential), reduced development complexity (no need for manually balanced branching systems), and greater emotional depth (LLMs are well-suited for choosing responses with narrative weight). The AI-driven narrative decision-making engine architecture also supports feasibility across a wide range of game sizes and genres, with a plug-and-play SDK and the potential for local or cloud-based deployment.

The AI-driven narrative decision-making engine empowers game developers to bring world populations to life with far less effort and greater creative control. It aligns with industry goals of making advanced AI more accessible while solving real pain points in narrative game design. By offering a scalable, narrative-aligned, and technically manageable method for AI-assisted decision-making, the engine represents a significant evolution in how dynamic NPC behavior can be designed and deployed.

By way of example, a developer creates an NPC named Ralan, a proud and arrogant warrior whose family was killed by bandits. In the game, the player has had multiple interactions with Ralan. In one encounter, the player saved a town from a group of bandits, an act that aligns with Ralan's hatred for them. In another moment, the player made fun of Ralan's fighting skills during a tavern conversation, bruising his ego. On a different mission, the player let Ralan get knocked out during a battle instead of helping him. These events are recorded in Ralan's narrative memory as developer-written text descriptions.

Later, the game reaches a moment where Ralan must decide how to respond to the player at the start of a major quest. The developer has provided a set of predefined options: (1) Ralan joins the player in the upcoming battle, (2) he refuses to help and walks away, or (3) he completes the mission but leaves without speaking. The AI-driven narrative decision-making engine compiles Ralan's personality, backstory, and past interactions with the player into a structured prompt and submits it to the LLM. Based on this narrative context, the LLM selects the second option—refuse to help—reasoning that while Ralan shares the player's disdain for bandits, his pride and hurt feelings override his sense of alliance. This choice is then returned as an index, triggering a pre-scripted dialogue and animation sequence where Ralan expresses his disappointment and walks away, leaving the player to face the challenge alone. This moment feels personal, reactive, and unscripted to the player, even though component—Ralan's context, the possible choices, and the final behavior—were created and constrained by the developer.

### Example Systems and Resources

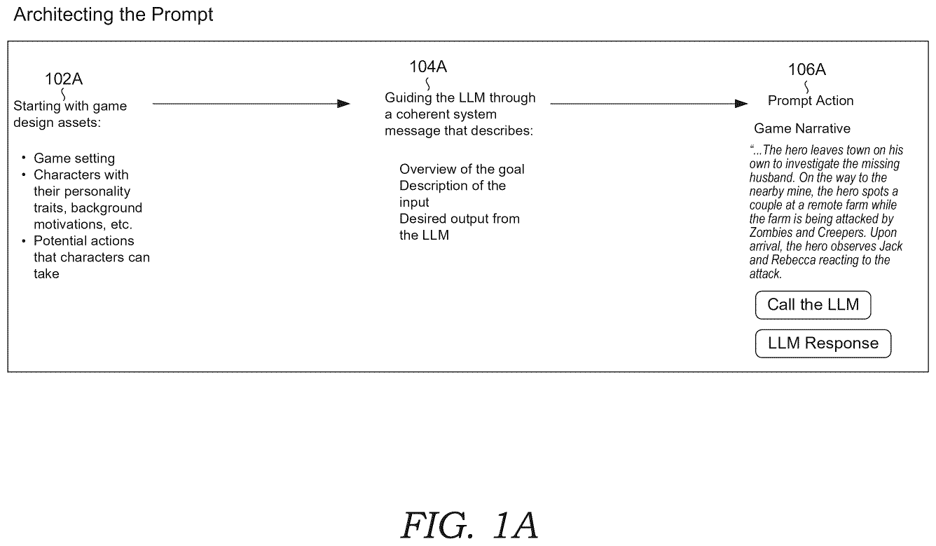

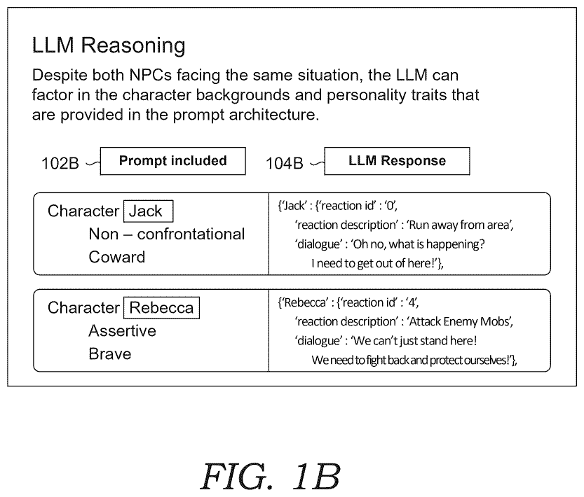

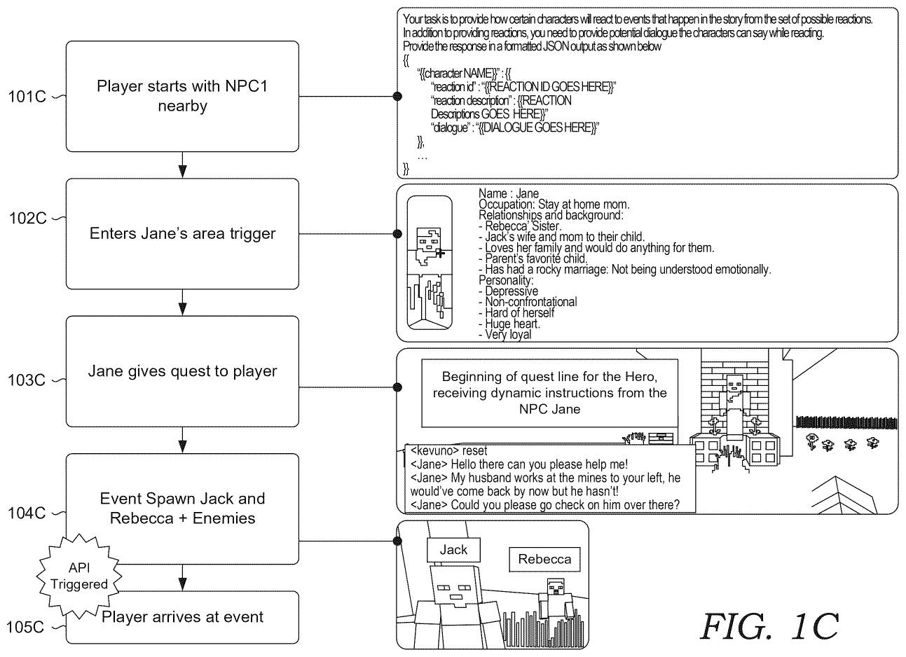

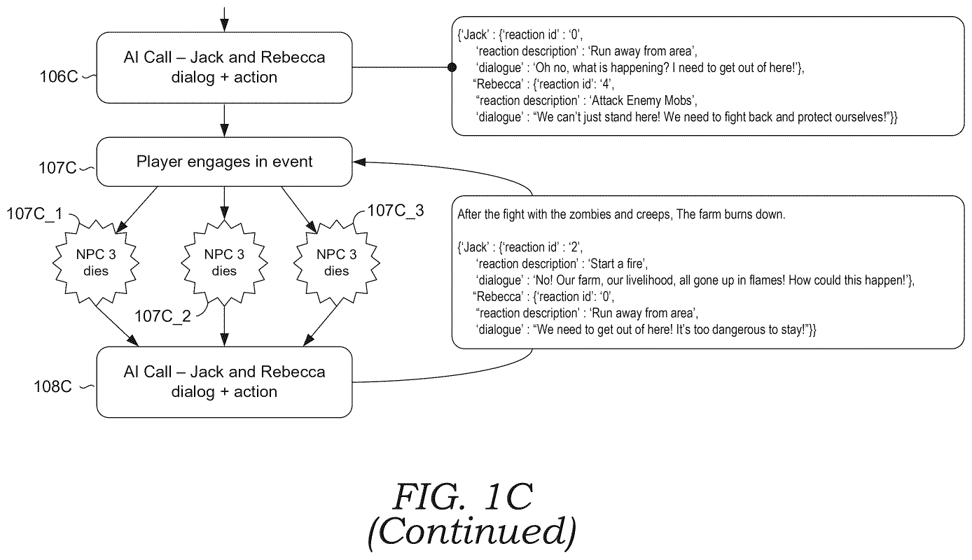

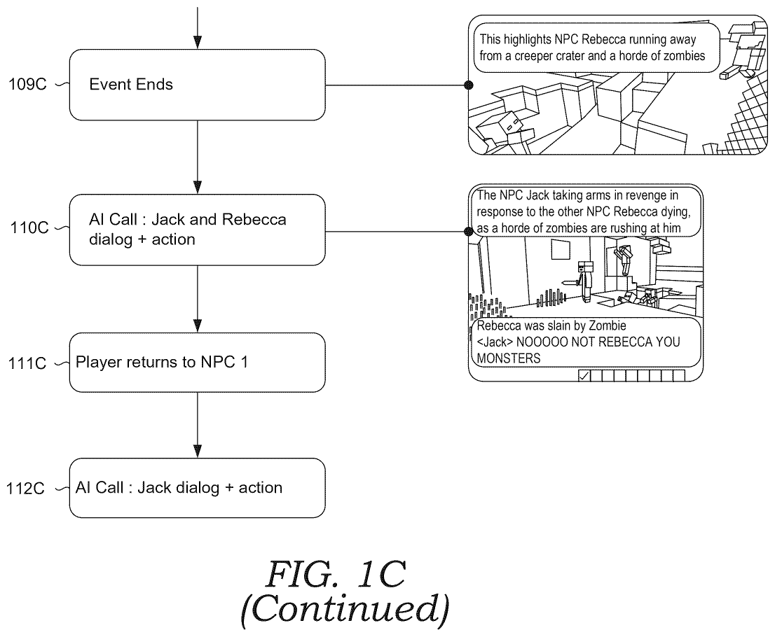

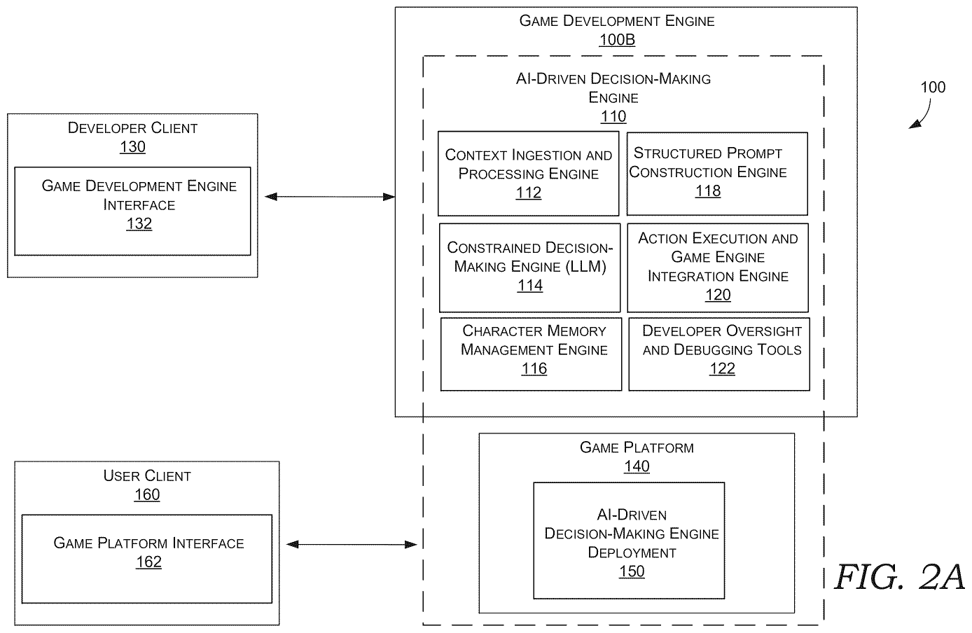

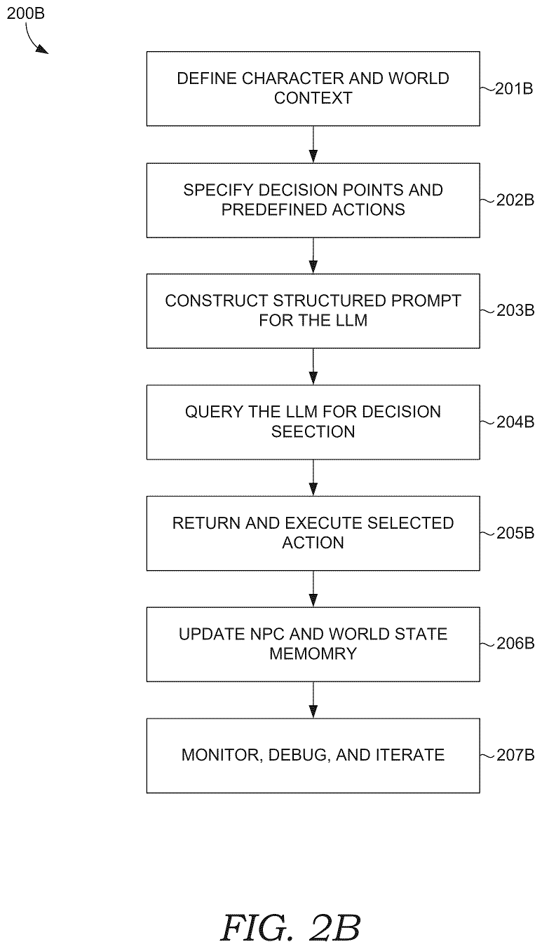

Aspects of the technical solution can be described by way of examples and with reference to FIGS. 1A-1C, 2A and 2B. With reference to FIG. 1A, FIG. 1A illustrates an AI-driven decision-making workflow flow for providing AI-driven narrative decision-making management using an AI-driven narrative decision-making engine. FIG. 1A illustrates prompt construction and AI interaction workflow of the AI-driven narrative decision-making engine. It maps directly to how the AI-driven narrative decision-making engine leverages structured developer-authored inputs, processes them into coherent prompts, and guides a large language model (LLM) to select contextually appropriate NPC actions from a developer-approved predefined list. The diagram outlines structured prompt construction and constrained decision-making features of the AI-driven narrative decision-making engine.

The process begins at 102A, where developers start with curated game design assets.
Name: Jane
Occupation: Stay at home mom.
Relationships and background:
   Rebecca's sister.
   Jack's wife and mom to their child.
   Loves her family and would do anything for them.
   Parent's favorite child.
   Has had a rocky marriage: Not being understood emotionally.
Personality:
   Depressive
   Non-confrontational
   Hard on herself
   Huge heart
   Very loyal

These include the game setting, NPCs with their personality traits, backstories, relationships, and motivations, and a list of developer-approved predefined actions. This information is structured in natural language and constitutes the character data and character profile components. For example, we see a character named Jane with a detailed narrative profile, and a small list of actions. This data is foundational for producing context-aware behavior and can be processed by a context ingestion and processing engine.
Action Id: 0, Action Description: Run away from area
Action Id: 1, Action Description: Attack the hero
Action Id: 2, Action Description: Start a fire

In 104A, the AI-driven narrative decision-making engine translates these narrative components into a structured prompt for the LLM. This includes a coherent message that outlines the goal of the prompt, describes the input data, and specifies the desired output format—typically a selection from the action list. FIG. 1A includes example AI-driven narrative decision-making engine message templates and prompt logic, which ensure that the LLM operates within constrained, predictable bounds. This step reflects how the AI-driven narrative decision-making engine enforces safety and narrative alignment by structuring the AI's role as a selector, not a generator.

game_system_message = ″″″
I want you to act as a game designer. You will come up with creative and
captivating stories that can engage players within their realism. You will
be given 3 pieces of information.
1- GAME SETTING: refers to the environment, atmosphere, and overall
world in which a video game takes place.
2- CHARACTERS: a list of characters with their backstory, personality,
abilities, relationships, and their role in the game's story.
3- REACTIONS: a list of possible reactions that each character can take
where each reaction is described by an ID.

At 106A, the AI-driven narrative decision-making engine executes a live inference interaction with the LLM using the constructed prompt. This section illustrates the “Prompt in Action,” where a brief story unfolds: the player approaches a farm under attack, and the LLM is queried to provide responses for the NPCs Jack and Rebecca. This real-time call to the AI-driven decision-making model corresponds to a runtime triggering event, where NPCs react to in-world stimuli based on previously defined context and memory. The LLM response shows the AI selecting specific actions for each character, expressed as output indices and referenced action descriptions. These outputs map back to predefined in-game behaviors and are passed to the action execution and game engine integration engine for display.

```
Your task is to provide how certain characters will react to events that
happen in the story from the set of possible reactions.
In addition to providing reactions, you need to provide potential dialogue
the character says while reacting.
Provide the response in a formatted JSON output as shown below:
{
  “<character NAME>”: {
  “reaction id”: [REACT ID GOES HERE],
  “actionDescription”: “[REACTION DESCRIPTION GOES HERE]”,
  “dialogue”: “[DIALOGUE GOES HERE]”
  }
}
{
  “Jack”: {
  “reaction id”: 0,
  “actionDescription”: “Run away from area”,
  “dialogue”: “Oh no, what is happening? I need to get out of here!”,
  },
  “Rebecca”: {
  “reaction id”: 2,
  “actionDescription”: “Start a fire”,
  “dialogue”: “We can't just stand here! We need to fight back and
protect ourselves!”
  }
}
```

With reference to FIG. 1B, FIG. 1B illustrates LLM reasoning workflow associated with the AI-driven narrative decision-making engine and its ability to generate distinct, character-consistent responses based on personality traits and background data provided by the developer. As shown, the AI-driven narrative decision-making engine generates differentiated outputs for two NPCs—Jack and Rebecca—even when both face the same in-game event. This capability is associated with the context-aware inference functionality of the AI-driven narrative decision-making engine, which is powered by the integration of character memory, character profiles, and developer-approved predefined actions into a structured AI prompt.

At 102B, “Prompt included,” identifies simplified personality traits and emotional descriptors that were fed into the prompt as part of each character's character data. Jack is described as non-confrontational and cowardly, while Rebecca is characterized as assertive and brave. This background is processed by a context ingestion and processing engine and incorporated into structured prompt construction, forming a unified input for the AI-driven decision-making model. These profiles are also part of the character's evolving character memory, which influences how future decisions will be shaped. The distinctions between characters, even in the same situation, allow for individualized reasoning and response, and these profiles become part of each NPC's evolving character memory, influencing future decisions as well.

At 104B, “LLM Response,” a structured output is returned from the AI-driven narrative decision-making engine after processing the prompt. The LLM response for Jack shows that he selects reaction ID 0, which corresponds to “Run away from area”—a fitting behavior for someone labeled a coward. His dialogue—“Oh no, what is happening? I need to get out of here!”—is aligned with that decision and demonstrates an accurate emotional match to his personality.

In contrast, Rebecca selects reaction ID 1, corresponding to “Attack Enemy Mobs.” Her dialogue—“We can't just stand here! We need to fight back and protect ourselves!”—reflects a bold and proactive stance, consistent with her assertive and brave character. Despite encountering the same event, the LLM selects divergent behaviors based on personality-driven narrative context.

This distinction highlights the strength of the constrained decision-making engine—the model is not generating random or open-ended actions but instead selecting from developer-approved predefined actions based on narrative context. The structured output ensures that the selected action pointer maps directly to an in-game behavior via the action execution and game engine integration engine.

In this way, the LLM reasoning within the AI-driven narrative decision-making engine is not generic but guided by developer-authored context rather than probabilistic generation. The LLM leverages nuanced, individualized prompts that account for character background, relationships, personality, and evolving world state. As demonstrated, even under identical conditions, NPCs can exhibit meaningful, believable behavioral divergence, reinforcing immersion and deepening narrative complexity while keeping the developer fully in control.

FIG. 1C illustrates an AI-driven narrative decision-making engine workflow associated with execution of an AI-driven NPC interaction, demonstrating how the AI-driven narrative decision-making engine integrates into a game environment. It follows a structured workflow where NPCs dynamically respond to player actions, utilizing predefined decision points, structured AI calls, and scripted event triggers to maintain narrative coherence and gameplay consistency. The AI-driven narrative decision-making engine workflow aligns with the technical solution's modular architecture, particularly in how it handles event detection, decision-making, memory updates, and real-time action execution.

The process begins at step 101C, where the player starts with NPC1 nearby. As the player moves forward and enters Jane's area trigger, at step 102C, leading Jane to give the player a quest at step 103C.

Following this, Jack and Rebecca spawn alongside with enemies at step 104C. The game platform detects that the player has arrived at the event step 105C and triggers an API Call, instructing the AI-driven narrative decision-making engine to determine the appropriate dialogue and action for Jack and Rebecca at step 106C. The AI-driven narrative decision-making engine formats a prompt containing and the AI-driven decision-making model processes this prompt and selects an output/action pointer.

As the player engages in the event 107C, the AI-driven narrative decision-making engine dynamically tracks NPC deaths (107C_1, 107C_2, 107C_3), updating the character memory management system in real time. The AI-driven narrative decision-making engine continuously evaluates the changing environment and initiates another AI Call at step 108C, ensuring that Jack and Rebecca react appropriately to the unfolding battle.

Once the event ends at step 109C, the AI-driven narrative decision-making engine processes another call for Jack and Rebecca's dialogue at step 110C, ensuring that their responses reflect the immediate combat outcome and past narrative context. As the player returns to NPC1 at step 111C, another AI Call at step 112C ensures that the NPC's (Jack) dialogue is adjusted based on the previous quest progress and world state changes.

FIG. 2A illustrates a cloud computing system 100, game development engine 100B, AI-driven narrative decision-making engine 110, context ingestion and processing engine 112, constrained decision-making engine 114, character memory management engine 116, structured prompt construction engine 118, action execution and game engine integration engine 120, and developer oversight and debugging tools 122; game platform 140 and AI-driven decision making engine deployment 150; developer client 130 and game development engine interface 132; and user client 160 and game platform interface 162.

The cloud computing system 100 provides the foundational infrastructure for distributed computing, ensuring that the AI-driven narrative decision-making engine 110 can scale efficiently by leveraging cloud-based resources. The AI-driven narrative decision-making engine 110 is a structured and scalable system designed to enhance NPC decision-making in games by integrating developer-defined constraints with AI-driven selection mechanisms. This ensures that NPC interactions remain dynamic, responsive, and contextually relevant while maintaining safety, predictability, and narrative coherence.

The AI-driven narrative decision-making engine operates within a two-tier architecture, where the game development engine 110B is used for configuring and testing AI-driven NPC behavior, and the game platform 140 executes these behaviors in live gameplay. Developers interact with the AI-driven narrative decision-making engine 110 through a dedicated interface, defining NPC attributes, decision logic, and world interactions before deploying them into a game environment. During gameplay, players experience AI-driven NPC interactions that react to their choices, past behaviors, and evolving game states.

Within the game development engine 100B, the AI-driven narrative decision-making engine 110 performs several functions. The context ingestion and processing engine 112 gathers and structures character attributes, past interactions, and game world conditions to ensure NPC decisions are made within the context of the game's evolving narrative. This involves tracking NPC-specific details, personality traits, and relationships while continuously updating the game's world state. The structured prompt construction engine 118 generates standardized input prompts based on an NPC's memory, the current world state, and a set of predefined actions created by developers. These prompts ensure that AI-driven decision-making is consistently formatted, enabling reliable and predictable NPC responses.

The constrained decision-making engine 114 ensures that NPC behaviors remain within the bounds of developer-defined constraints by allowing the AI model (e.g., a Large Language Model “LLM”) to select only from a predefined list of available actions. Unlike generative AI models that produce open-ended outputs, this AI-driven narrative decision-making engine 110 ensures that NPC behavior remains intentional, eliminating risks of unpredictable dialogue or actions. The selected action is returned as a pointer to a predefined action, allowing for seamless execution within the game engine.

As such, the output can refer to a structured identifier returned by an AI-driven decision-making model that maps directly to a developer-approved predefined action. In one embodiment, it may include both an action ID (e.g., “reaction id”: 0) and an associated action description (e.g., “Run away from area”), which together specify the NPC's selected behavior. This output may also include a narrative justification or dialogue line consistent with the character's memory, personality, and current world context. The action pointer enables deterministic mapping to in-game logic, ensuring that the selected behavior is safely executable and contextually appropriate, while allowing for personalized expression.

Character memory management engine 116 supports maintaining NPC consistency over time. The character memory management engine 116 logs and tracks all past NPC interactions, decisions, and emotional responses to ensure that future choices are influenced by prior experiences. This allows NPCs to display evolving behaviors based on their relationship with the player, past events, and ongoing game world changes. Memory persistence enhances realism by ensuring that NPCs recall significant encounters and make future decisions accordingly.

Once a decision has been made, the action execution and game engine integration engine 120 ensures that the corresponding in-game behavior, such as animations, dialogue, and state changes, is triggered in real time. This integration with the game engine ensures that AI-driven decisions translate seamlessly into gameplay. Additionally, the developer oversight and debugging tools 122 provide logging of AI inputs, outputs, and justifications, allowing developers to review and refine decision-making processes. Developers can simulate different NPC interactions across various game states, ensuring that AI-driven behaviors align with intended narrative outcomes before deployment.

Once deployed to the game platform 140 the AI-driven narrative decision-making engine operates as a runtime-optimized AI-driven narrative decision-making engine deployment 150 that processes AI-driven decisions in real-time. During gameplay, the AI-driven narrative decision-making engine deployment 150 detects triggering events, such as player interactions or world changes, and determines when an NPC must evaluate a decision. It retrieves relevant character memory and world state, constructs an AI prompt, and queries the AI model to determine the most contextually appropriate action. The AI model processes the structured input and selects an action pointer, which is then executed by the game engine.

After execution, the AI-driven narrative decision-making engine deployment 150 updates the NPC's memory and the game world state to ensure that future decisions reflect past experiences, maintaining long-term coherence. This structured approach ensures that NPC behavior remains dynamic and responsive while preserving a high degree of developer control.

The user client 160 provides the interface through which players interact with NPCs and experience AI-driven behaviors. As players engage with NPCs, the game platform 140 continuously provides a narrative in a way that feels organic while remaining fully controlled by the developer. The developer client 130 serves as the primary interface for defining, testing, and refining AI-driven NPC behaviors. Developers interact with the game development engine 100B to configure decision points, approve predefined actions, and validate AI-driven interactions before deployment. Through a structured simulation environment, they can test NPC behaviors across different game scenarios, ensuring that AI-driven interactions behave as expected under various conditions.

The AI-driven narrative decision-making engine 110 workflow follows a structured process, beginning with the development phase, where developers define character data, decision points, and predefined actions. The AI-driven narrative decision-making engine 110 then constructs prompts based on NPC memory, world state, and available actions before querying the AI model to select an appropriate response. Developers test and refine AI behaviors in a controlled environment before deploying the AI-driven narrative decision-making engine 110 to the live game. During gameplay, the AI-driven narrative decision-making engine deployment 150 detects player interactions, retrieves NPC context, processes AI-driven decisions, executes predefined actions, and updates character memory and world state to maintain coherence. The AI-driven narrative decision-making engine 110 continuously logs AI behavior, allowing for traceability, debugging, and refinement.

For clarity and efficient reference, a glossary of key terms and concepts pertinent to the technical solution is provided below.

Character Data: Structured input describing an NPC's attributes, personality, history, and context. Used to build a dynamic character profile for AI-assisted decisions.

Character Profile: A dynamic data structure generated from character attributes and game context that informs how an NPC makes decisions.

AI-Driven Decision-Making Model: A large language model (LLM) that interprets narrative context and selects from a fixed list of developer-defined actions, rather than generating content freely.

Decision Point/Decision Event: A moment in gameplay when an NPC is prompted to make a choice based on current game conditions, triggering the AI decision process.

Prompt: A formatted natural language input that includes an NPC's memory, current world state, and possible actions, used by the LLM to select the most appropriate response.

Character Memory: A record of past interactions, choices, and emotional or narrative history specific to an NPC, used to influence future decision-making.

Game World State: A representation of dynamic global conditions (e.g., environmental changes, quest progress, recent events) that affect NPC behavior across the game.

Developer-Approved Predefined Actions: A limited set of developer-written actions available to an NPC, each mapped to in-game behaviors and reviewed for safety and narrative consistency.

Output/Action Pointer: The LLM's response—a reference (typically an index) to one predefined action from the developer-approved list.

Game Logic Execution/Game Sequence: The engine-side behavior triggered by the selected action, such as animations, dialogue, and game state changes visible to the player.

Updating Character Memory and World State: The process of modifying an NPC's internal memory and the global game context after a decision is executed, enabling persistent and reactive gameplay.

Non-Player Character (NPC): A game-controlled character whose behavior is governed by the AI-driven narrative decision-making engine, contributing to immersive and dynamic storytelling.

Developer Integration and Simulation: The process by which developers configure, test, and refine the AI decision system, including simulations of various character and game states.

Logging AI Inputs, Outputs, and Justifications: The capability to log and review all AI decision inputs, outputs, and reasoning to support debugging, quality control, and narrative consistency.

Triggering Event/Game Event Detection: A gameplay condition that signals when an NPC must evaluate a new decision, initiating prompt construction and AI evaluation.

Pointer to Action: A reference (typically an index or identifier) returned by the AI to indicate which predefined action should be executed by the game engine.

Execution Mapping: The process of connecting a selected AI decision to the corresponding pre-scripted animation, dialogue, or gameplay response in the game engine.

Integration by Game Developer: The implementation workflow through which developers author character data, define action sets, and integrate the AI engine into the game runtime.

Testing and Simulation: The offline evaluation of AI decision-making across various scenarios and states, used for debugging, tuning, and validating narrative behavior.

Natural Language Encoding: The practice of defining character data, world context, and action choices using plain English, enabling non-programmers to contribute to AI behavior design.

Developer-Approved Constraints: Rules and filters defined by developers that limit the AI's choices to safe, narrative-consistent, and contextually appropriate actions.

Context-Aware Inference: The LLM's ability to select the most appropriate action based on narrative context derived from an NPC's memory and the evolving game world.

Real-Time and Deterministic Execution: The AI decision produces a consistent output that is executed immediately during gameplay, ensuring predictable and reproducible NPC behavior.

Reusability of Content: The ability to apply the same decision-making framework across different NPCs and scenarios, supporting efficient and scalable content design.

Traceability/Decision Provenance: The system's ability to track and review the entire AI decision path—including inputs, outputs, and rationale—for transparency and iterative improvement.

With reference to FIG. 2B, FIG. 2B a flow chart 200B associated with providing an AI-driven narrative decision-making management using an AI-driven narrative decision-making engine in accordance with embodiments described herein. The technical solution of the AI-driven narrative decision-making engine can be explained by way of steps.

At step 201B-Define Character and World Context: Before the AI can make decisions, the game must establish a structured representation of NPCs and the game world. Developers provide natural language descriptions detailing NPC backstories, personality traits, and motivations. Each NPC's memory begins with a set of static attributes (e.g., trust level, aggression, moral alignment) and evolves dynamically as new interactions occur. Additionally, developers define world context, including significant global events, environmental conditions, and player-driven changes. These inputs are stored in a structured database or game state memory, ensuring that NPCs react differently based on their individual knowledge and past experiences.

At step 202B—Specify Decision Points and Predefined Actions:

Developers identify key points in the game where NPCs makes decisions. Each decision point is linked to a structured narrative description of the current scenario, including the immediate environment, relevant past events, and available NPC actions. Developers then define a finite set of possible actions, ensuring that NPC behavior remains within narratively coherent and mechanically appropriate boundaries. These actions are written in natural language and associated with predefined game scripts that control animations, dialogue, or world state changes. Unlike generative AI, AI-driven narrative decision-making engine does not create actions at runtime—it only selects from developer-provided choices, ensuring control and predictability.

At step 203B—Construct Structured Prompt for the LLM: When an NPC reaches a decision point, AI-driven narrative decision-making engine compiles a structured prompt to send to the LLM. This prompt consists of three key elements: (1) the NPC's individual memory, including personality, past interactions, and evolving traits; (2) the current world state, reflecting global events and relevant environmental conditions; and (3) the list of developer-defined action choices. The AI-driven narrative decision-making engine formats these elements into a standardized text-based input that ensures consistency across different scenarios. By structuring the prompt in a controlled manner, AI-driven narrative decision-making engine prevents the LLM from making hallucinated or out-of-context decisions and instead limits its role to choosing the most contextually appropriate response.

At step 204B—Query the LLM for Decision Selection: Once the structured prompt is ready, AI-driven narrative decision-making engine submits the request to an LLM model, which evaluates the context and action list. The LLM uses text classification techniques rather than open-ended text generation, ensuring it selects the most narratively consistent option from the provided set. The model considers factors such as emotional weight, character consistency, and world state dependencies to determine which action aligns best with both the character's history and current situation. The output is a numerical index corresponding to the selected action, preventing any unintended language generation while ensuring predictable and reproducible decision-making.

At step 205B—Return and Execute Selected Action: The numerical index of the chosen action is returned to the game engine, which then retrieves the corresponding predefined scripted behavior and executes it. This execution can involve dialogue playback, animation triggering, NPC movement, or interaction with world objects. Because all possible outcomes have been scripted beforehand, the AI cannot introduce unwanted behaviors, keeping responses within developer-approved constraints. The execution system ensures seamless integration with real-time gameplay, allowing NPCs to react dynamically while maintaining the stability of the game world.

At step 206B—Update NPC and World State Memory: To ensure long-term coherence, AI-driven narrative decision-making engine updates the NPC's memory and world state following each decision. The selected action is recorded in a persistent data store, allowing future decision points to account for past interactions. For example, if an NPC previously forgave a player for stealing, this event is stored and influences how the NPC reacts to future theft attempts. Similarly, the world state tracker updates relevant global conditions (e.g., a town's reputation toward the player changes after a major event). These updates enable emergent storytelling, where past actions shape ongoing interactions without requiring developers to manually script every possible consequence.

At step 207B—Monitor, Debug, and Iterate: AI-driven narrative decision-making engine maintains a detailed decision log that tracks every AI-driven choice along with the structured input that led to the decision. Developers can review why the AI chose a specific action by examining the logged decision process, which includes a hidden narrative justification generated by the LLM. Debugging tools allow developers to manually override choices, adjust NPC memory values, and refine the weightings of different decision factors. Additionally, simulation tools can run multiple test cases, enabling developers to observe how NPCs behave across different player interactions and fine-tune constraints for a more polished game experience.

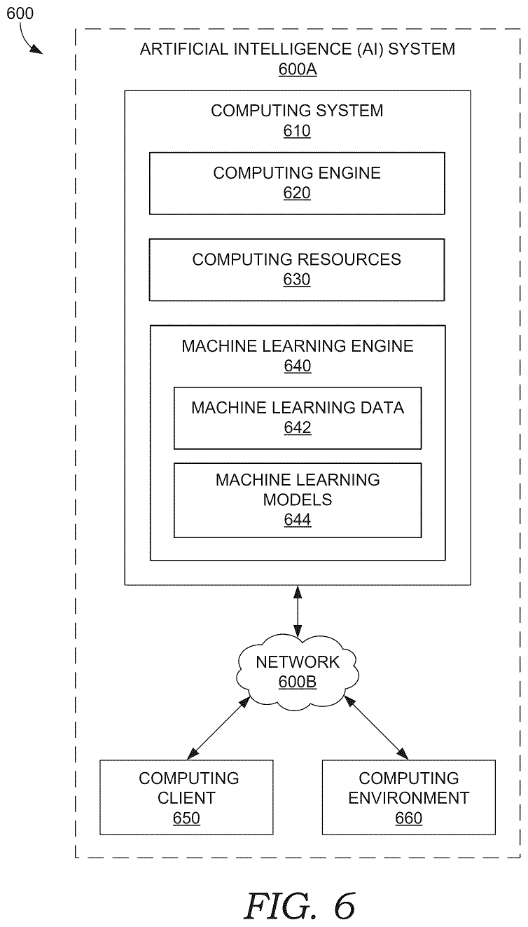

Aspects of the technical solution have been described by way of examples and with reference to FIGS. 1A-1C, 2A and 2B. FIG. 2A is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 2A illustrates a high-level architecture of the cloud computing system 100 in accordance with implementations of the present disclosure, among other engines, managers, generators, selectors, or components not shown (collectively referred to herein as “components”).

### Example Methods

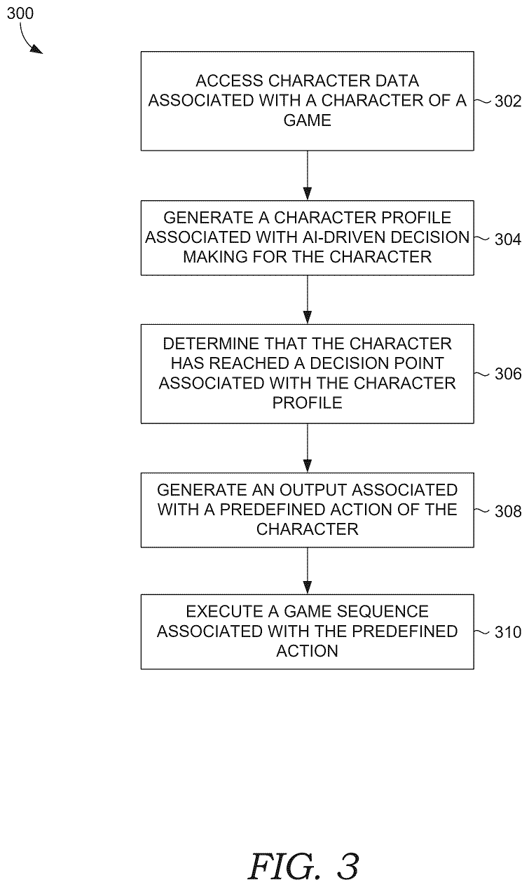

With reference to FIGS. 3, 4, and 5, flow diagrams are provided illustrating methods for providing AI-driven narrative decision-making management using an AI-driven narrative decision-making engine in an artificial intelligence system. The methods may be performed using the artificial intelligence system described herein. In embodiments, one or more computer-storage media having computer-executable or computer-useable instructions embodied thereon that, when executed, by one or more processors can cause the one or more processors to perform the methods (e.g., computer-implemented method) in the artificial intelligence system (e.g., a computerized system).

Turning to FIG. 3, a flow diagram is provided that illustrates a method 300 for providing AI-driven narrative decision-making management using an AI-driven narrative decision-making engine in an artificial intelligence system. At block 302, access character data associated with a character of a game. At block 304, using the character data, generate a character profile associated with AI-driven decision-making for the character in the game. At block 306, determine that the character has reached a decision point associated with the game. At block 308, based on determining that the character has reached the decision point, generate a prompt for an AI-driven decision-making model. At block 310, using the AI-driven decision-making model, generate an output associated with a predefined action of the character. At block 312, execute a game sequence associated with the predefined action.

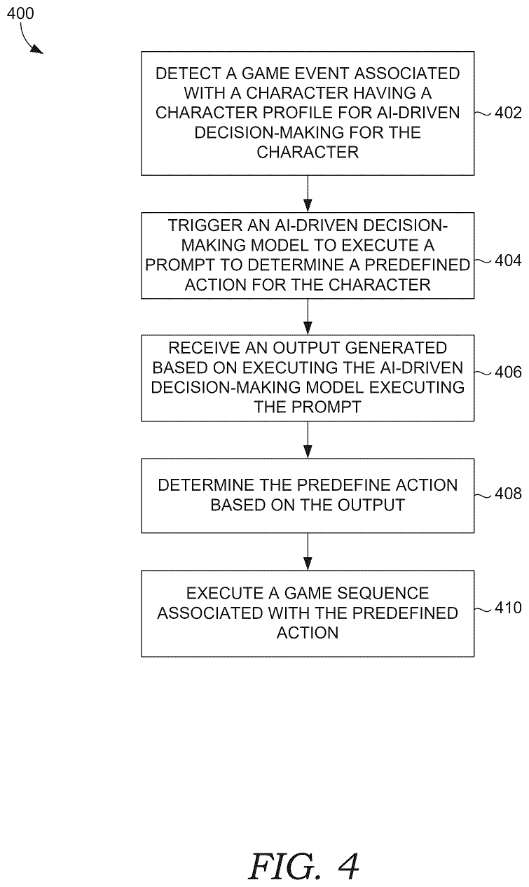

Turning to FIG. 4, a flow diagram is provided that illustrates a method 400 for providing AI-driven narrative decision-making management using an AI-driven narrative decision-making engine in an artificial intelligence system. At block 402, detect a game event associated with a character having a character profile for AI-driven decision-making for the character. At block 404, based on detecting the game event, trigger an AI-driven decision-making model to execute a prompt to determine a predefined action for the character. At block 406, receive an output generated based on the AI-driven decision-making model executing the prompt. At block 308, determine the predefined action based on the output. At block 410, execute a game sequence associated with the predefined action.

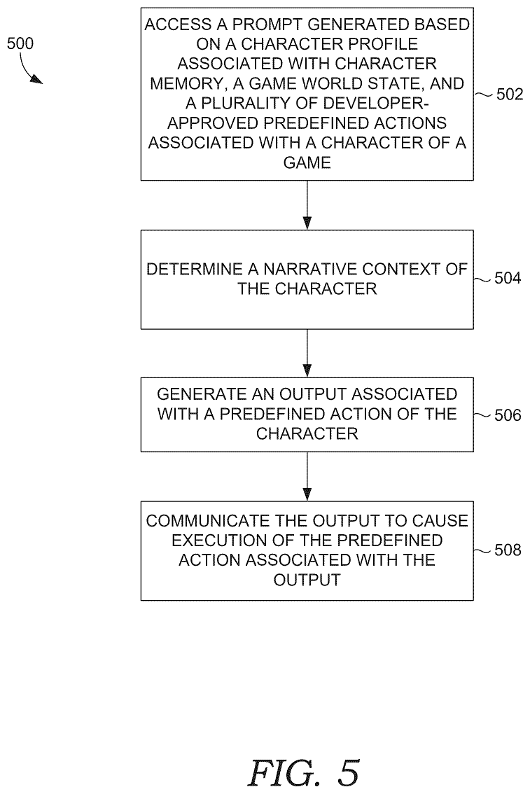

Turning to FIG. 5, a flow diagram is provided that illustrates a method 500 for providing AI-driven narrative decision-making management using an AI-driven narrative decision-making engine in an artificial intelligence system. At block 502, access, at an AI-driven decision-making model, a prompt generated based on a character profile associated with a character memory, a game world state, and a plurality of developer-approved predefined actions associated with a character of a game. At block 504, based on the prompt and the character profile, determine a narrative context of the character. At block 506, based on the narrative context, generate an output associated with a predefined action of the character. At block 508, communicate the output to cause execution of the predefined action associated with the output.

### Technical Improvement

Embodiments of the present techniques have been described with reference to several inventive features (e.g., operations, systems, engines, and components) associated with an artificial intelligence system. Inventive features described include operations, interfaces, data structures, and arrangements of computing resources associated with providing the functionality described herein relative with reference to an AI-driven narrative decision-making engine. Functionality of the embodiments of the present invention have further been described, by way of an implementation and anecdotal examples—to demonstrate that the operations for providing the AI-driven narrative decision-making engine as a solution to a specific problem in artificial systems technology to improve computing operations in game development systems.

The AI-driven narrative decision-making engine offers multiple advantages, including ensuring safety and narrative control by restricting AI decisions to developer-approved actions. It enables scalability by allowing new NPCs and actions to expand interactions exponentially without requiring additional scripting. The AI-driven narrative decision-making engine 110 maintains consistency and realism by allowing NPCs to recall past interactions, making their behavior feel persistent and responsive to the player's actions. It also improves development efficiency by enabling designers to define decision logic in natural language, reducing reliance on complex scripting. Finally, debugging and traceability features allow developers to review AI-driven decisions, refine NPC behaviors, and maintain transparency in AI decision-making.

The AI-driven narrative decision-making engine 110 bridges the gap between AI-assisted decision-making and structured game design, allowing NPCs to react dynamically while ensuring that all decisions remain within the bounds of developer intent. By leveraging a structured AI pipeline that separates development, processing, and execution, the AI-driven narrative decision-making engine enables game developers to create intelligent, memory-driven NPC interactions while maintaining full control over their behavior. This modular and scalable approach represents a significant advancement in NPC behavior design, transforming how AI-driven decision-making is integrated into modern game development.

### Additional Support for Detailed Description Example Artificial Intelligence (AI) System in a Computing Environment

Referring now to FIG. 6, FIG. 6 illustrates a computing environment in which implementations of the present disclosure may be employed. In particular, FIG. 6 shows a high level architecture of an example cloud computing platform 600, artificial intelligence (AI) system 600A, and computing system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing platform 600 provides computing system resources for different types of managed computing environments. For example, the cloud computing platform supports delivery of computing services—including compute, servers, storage, databases, networking, and intelligence. The components of cloud computing platform 600 may communicate with each other over a network 600B which may include, without limitation, one or more local area networks (LANs) and/or wide area networks (WANs).

The AI system 600A provides a specialized infrastructure designed to support the computational demands of artificial intelligence (AI) workloads, including both training and inference tasks. The AI backend network systems 600A consists of interconnected components that facilitate the efficient processing, communication, and management of data within a distributed computing environment. Operations include data processing, handling input data, intermediate results, and output data, alongside complex computations for AI tasks, communication facilitating seamless interaction among components, and resource management overseeing optimal utilization of compute nodes, accelerators (e.g., GPUs, TPUs), memory, and storage. Interfaces encompass network interfaces enabling high-speed communication between nodes, APIs providing standardized interaction methods for developers, and management interfaces for system monitoring and administration. Data support functionalities include storage, data movement, transformation, and replication with backup mechanisms, ensuring data durability and reliability. In this way, the AI backend network system serves as the backbone infrastructure for AI workloads, facilitating efficient and scalable AI processing across distributed computing environments through its comprehensive operations, interfaces, and data management functionalities.

The cloud computing platform 600 provides the foundational infrastructure and resources for deploying and managing computing workloads, including AI. AI system 600A includes specialized infrastructures tailored for supporting the unique computational demands of AI workloads. The relationship between the two involves resource provisioning, integration, orchestration, and data processing, enabling organizations to leverage cloud-based resources effectively for AI development and deployment.

The computing system 610 provides computing functionality for computing environments. For example, the computing system 610 is a platform or framework that leverages advanced technologies such as artificial intelligence (AI), machine learning (ML), data mining, and big data analytics to extract actionable insights and knowledge from large and complex datasets. In this way, the computing system 610 provides a computing environment that enables organizations to make informed decisions and optimize operations.

The computing system 610 includes a computing engine 620 that is a computing environment that supports executing computational tasks associated with the computing system 610. The computing engine 620 can be a hardware or software component that performs computational operations, such as, mathematical calculations, data processing, and algorithm execution. The computing system 610 integrates computing resources 630 into computing system 610 to effectively provide computing functionality in a computing environment.

The computing resources 630 refer to computing elements (e.g., components, capability, or entities) that collectively enable the computing engine 620 operations. The computing resources 630 encompass a spectrum of computing elements, beginning with the diverse operations the computing resources 630 can perform, ranging from complex computations to data manipulations. Interfaces, an integral part of the computing resources 630, provide the means for both user interaction and seamless integration with external systems, ensuring a dynamic and interactive computing experience. The data facet of the data computing resources 630 involves various types: input data, which is the information provided for processing; processing data, representing the data manipulated during computational tasks; and output data, the results generated by the computing engine 620. In this way, the computing resources 630 support the broader computing engine 620 and computing system 610.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 640 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The computing client 650 supports access to computing system 610. The computing client 650 can be provided as a user client or an administrator client to support user and administrator functionality associated with the computing environment 660, computing engine 620, or computing system 610. The computing client 650 can also support accessing computing visualizations and causing display of the computing visualization. The computing client 650 can include a computing engine client that supports receiving computing information associated computing engine 620 output from the computing system 610 and causing presentation of the computing information. The computing information can specifically include computing visualizations associated with the computing engine 620 output.

Computing environment 660 is a computing environment that is integrated into the computing system 610. The computing environment 660 is characterized by an infrastructure, where data from various sources within the ecosystem, including servers, networks, applications, sensors, and user interactions, can be aggregated and processed by the computing system 610 to perform computing tasks. The computing environment 660 can be associated with middleware and integration layers facilitate seamless data flow, while computing infrastructure, encompassing cloud-based resources, distributed computing frameworks, and optimized storage systems, supports functionality associated with the computing.

### Example Distributed Computing System Environment

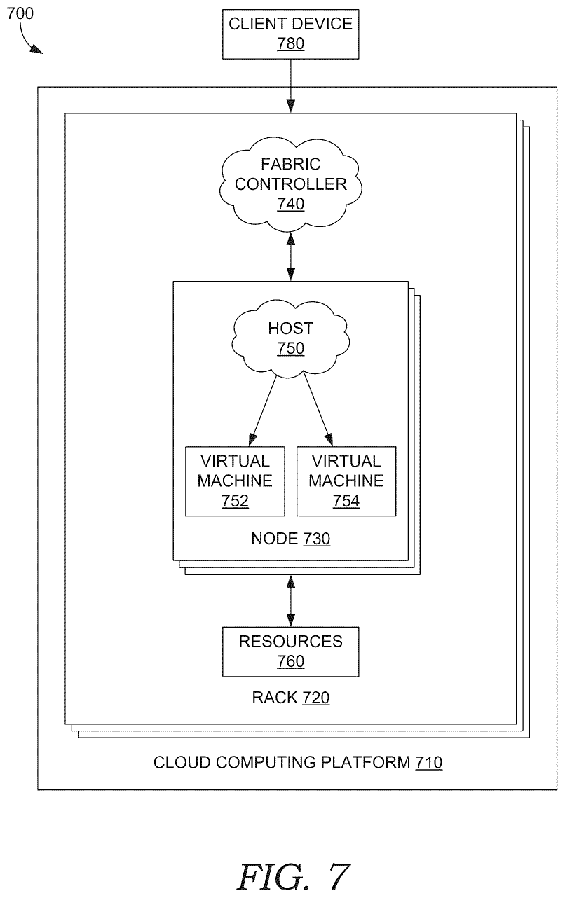

Referring now to FIG. 7, FIG. 7 illustrates an example distributed computing environment 700 in which implementations of the present disclosure may be employed. In particular, FIG. 7 shows a high-level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing platform 710 in a data center can be configured to host and support operation of endpoints of a particular service application. Cloud computing platform 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 800 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### Example Computing Environment

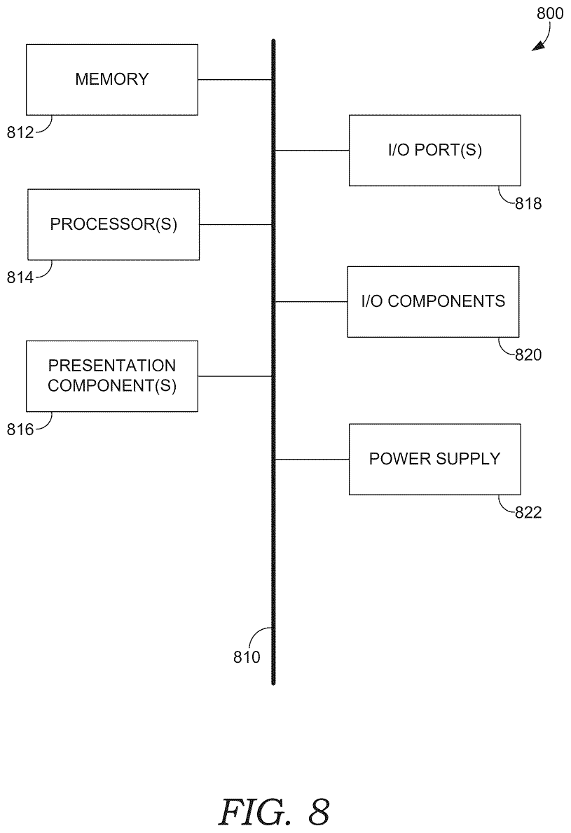

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### Additional Structural and Functional Features

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors;
computer memory storing computer-useable instructions that, when used by the one or more computer processors, cause the one or more computer processors to perform operations, the operations comprising:
accessing character data associated with a character of a game;
using the character data, generating a character profile associated with AI-driven decision-making for the character in the game;
determining that the character has reached a decision point associated with the game;
based on determining that the character has reached the decision point, generating a prompt for an AI-driven decision-making model, the prompt is generated using the character profile;
using the AI-driven decision-making model, generating an output associated with a predefined action of the character; and
executing a game sequence associated with the predefined action.

2. The system of claim 1, wherein the character data comprises character attributes and game world context described in natural language.

3. The system of claim 1, wherein the character data comprises developer-approved predefined actions for the character, wherein the developer-approved predefined actions are linked to game logic of the game.

4. The system of claim 1, wherein generating the prompt using the character profile is based on one or more of: character memory, a game world state, and a plurality of developer-approved predefined actions associated with the character.

5. The system of claim 1, wherein the output is a pointer to the predefined action associated with the character profile.

6. The system of claim 1, wherein the output further comprises a predefined action description and dialogue for the character.

7. The system of claim 1, the operations further comprising updating character memory and game world state associated with the character.

8. The system of claim 1, wherein the character is a non-player character, and the AI-driven decision-making model is a large language model.

9. The system of claim 1, wherein the character data is received from a game developer who integrates the AI-driven decision-making model to the game, tests and simulates AI-driven decision-making across different scenarios and character states.

10. The system of claim 9, the operations further comprising logging AI inputs, outputs, and justification as part of AI-driven decision-making simulations.

11. One or more computer-storage media having computer-executable instructions embodied thereon that, when executed by a computing system having a processor and memory, cause the processor to perform operations, the operations comprising:
detecting a game event associated with a character having a character profile for AI-driven decision-making for the character;
based on detecting the game event, triggering an AI-driven decision-making model to execute a prompt to determine a predefined action for the character;
receiving an output generated based on the AI-driven decision-making model executing the prompt;
determining the predefined action based on the output; and
executing a game sequence associated with the predefined action.

12. The media of claim 11, wherein the character profile is generated based on character data comprising character attributes and game world context described in natural language.

13. The media of claim 11, wherein the prompt is generated using the character profile is based on one or more of: character memory, a game world state, and a plurality of developer-approved predefined actions associated with the character.

14. The media of claim 11, the operations further comprising updating character memory and game world state associated with the character.

15. The media of claim 11, wherein the character is a non-player character, and the AI-driven decision-making model is a large language model.

16. A computer-implemented method, the method comprising:
accessing, at an AI-driven decision-making model, a prompt generated based on a character profile associated with a character memory, a game world state, and a plurality of developer-approved predefined actions associated with a character of a game;
based on the prompt and the character profile, determining a narrative context of the character;
based on the narrative context, generating an output associated with a predefined action of the character;
communicating the output to cause execution of the predefined action associated with the output.

17. The method of claim 16, wherein the character profile is generated based on character data comprising character attributes and game world context described in natural language.

18. The method of claim 16, wherein the output is a pointer to the predefined action associated with the character profile.

19. The method of claim 16, wherein the output further comprises a predefined action description and dialogue for the character.

20. The method of claim 16, wherein the character is a non-player character, and the AI-driven decision-making model is a large language model.
